(19) United States
(12) Patent Application Publication
(10) Pub. No.: US 2003/0081310 A1
(43) Pub. Date: May 1, 2003

(54) Microscopy method and apparatus

(76) Inventor: Dennis Q. McManus, Springfield, IL (US)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 10/306,573

(22) Filed: Nov. 27, 2002

Related U.S. Application Data
(63) Continuation-in-part of application No. 09/576,502, filed on May 23, 2000, now Pat. No. 6,490,083.
Application No. 09/576,502 is a continuation of application No. 09/150,113, filed on Sep. 9, 1998, now abandoned.

(51) Int. Cl. G02B 21/00; G02B 21/22; G02B 21/06

(52) U.S. Cl. 359/376; 359/368; 359/385

(57) ABSTRACT

A microscope having an objective for magnifying an image positioned at a focal plane of the objective. An elongate lens extends from a rear end adjacent the objective to a front end configured for penetrating the tissue of the living organism to position the lens adjacent cells inside the tissue. The lens is configured for transmitting light from a light source to the cells inside the tissue of the living organism adjacent the front end of the lens to illuminate the cells and for transmitting light from the cells back through the lens to the objective. A focusing mechanism moves the lens relative to the objective to position the lens so that the image plane of the lens corresponds with the focal plane of the objective thereby permitting the cells inside the tissue of the living organism to be viewed with the microscope. A microscope attachment which includes the lens and the focusing mechanism described above, and a method of viewing cells inside living tissue using such a microscope, are also disclosed.

### CROSS-REFERENCE TO RELATED APPLICATION

This application is a continuation-in-part of pending application Ser. No. 09/576,502, filed May 23, 2000, which is a continuation of application Ser. No. 09/150,113, filed Sep. 9, 1998, now abandoned.

### BACKGROUND OF THE INVENTION

The present invention relates to microscopes, and more particularly, to methods and apparatus for viewing and manipulating cells inside living tissue with a microscope.

Before tissue can be viewed using conventional microscopes, it must usually be removed from its host organism, especially when features below the surface of the tissue are viewed. However, living tissue cannot survive long after removal from its host without sophisticated support equipment. Further, the tissue may change if the support equipment does not precisely duplicate its natural environment. Although a few conventional microscopes (e.g., surgical microscopes) have been designed to view living tissue without removing it from its host, these microscopes have limited resolution. Therefore, small features cannot be seen with these microscopes.

Due to the inherent limitations of conventional microscopes, many features of living tissue have not been viewed directly. For instance, physical changes in the human brain resulting from internal processes have not been viewed at the cellular level. As a result, information such as how quickly connections (e.g., synapse connections) are made and lost within the brain is unknown. Further, viewing removed brain tissue does not permit clear understanding of these processes because complex behavior (e.g., speech or learning) cannot be studied when the tissue is removed from its host. The inability of conventional microscopes to view brain cell connections is particularly frustrating because it is envisioned that viewing these connections could answer questions concerning the causes of brain dysfunction such as Alzheimer's disease.

One of the reasons tissue must be removed from its host before it may be viewed by most conventional microscopes is that the tissue must be highly illuminated to be seen through the microscopes. Confocal optical microscopes eliminate this problem by illuminating the tissue with a laser aimed at the tissue through the lens of the microscope. These microscopes make it possible to view an object without an external illumination source. However, conventional confocal optical microscopes cannot view more than a very short distance (i.e., about 200 nm) below the surface of the tissue. Thus, deeper tissue cannot be viewed without separating the tissue from the living organism.

Conventional microscopes and methods of use have other disadvantages which limit their usefulness when viewing tissue inside a host. For instance, stains are ordinarily applied to tissue before being viewed with microscopes to improve the optical attributes of features within the tissue. However, the amount of stain used to produce suitable optical attributes frequently kills or injures cells in the tissue and sometimes harms the host. Therefore, conventional methods of applying stain are generally not appropriate when examining living tissue inside a host organism.

### SUMMARY OF THE INVENTION

Among the several objects and features of the present invention may be noted the provision of a microscope and a microscope attachment capable of viewing internal features of tissue without removing the tissue from its host; the provision of such a microscope and attachment which, in selected embodiments, enable small amounts of stains and/or other fluids to be precisely directed toward a particular site in tissue within the field of view of the microscope; the provision of such a microscope and attachment which, in selected embodiments, are capable of precisely positioning instruments for manipulation of tissue within the field of view of the microscope; the provision of a microscope and attachment which, in selected embodiments, have a fluid delivery system which delivers fluid to a site within the field of view of the microscope in amounts which are effective and substantially nontoxic; and the provision of a unique method of viewing cells inside tissue of living organisms.

Briefly, apparatus of this invention is an assembly for viewing cells inside tissue of a living organism. The assembly comprises a microscope having an objective for magnifying an image positioned at a focal plane of the objective and a light source adapted to direct light through the objective. An elongate lens extends from a rear end adjacent the objective to a front end configured for penetrating the tissue of the living organism to position the lens adjacent cells inside the tissue. The lens is configured for transmitting light from the light source to the cells inside the tissue of the living organism adjacent the front end of the lens to illuminate the cells and for transmitting light from the cells back through the lens to the objective. The lens has a focal plane adjacent its front end positioned at a location corresponding to the illuminated cells and an image plane adjacent its rear end. The assembly also includes a focusing mechanism for moving the lens relative to the objective along a longitudinal axis of the lens to position the lens so that the image plane of the lens corresponds with the focal plane of the objective thereby permitting the cells inside the tissue of the living organism to be viewed with the microscope.

In another aspect, the invention includes an attachment for use with a microscope. The attachment includes an elongate lens having a rear end and a front end, and a mount for mounting the lens on the microscope in a position in which the rear end of the lens is adjacent the objective and its front end is configured for penetrating the tissue of the living organism to position the lens adjacent cells inside the tissue. The lens is configured for transmitting light from the light source to the cells inside the tissue of the living organism adjacent the front end of the lens to illuminate the cells and for transmitting light from the cells back through the lens to the objective. The lens has a focal plane adjacent its front end positioned at a location corresponding to the illuminated cells and an image plane adjacent its rear end. The attachment also includes a focusing mechanism for moving the lens relative to the objective along a longitudinal axis of the lens to position the lens so that the image plane of the lens corresponds with the focal plane of the objective thereby permitting the cells inside the tissue of the living organism to be viewed with the microscope.

In yet another aspect, the invention includes a method of viewing cells inside tissue of living organisms. The method comprises the steps of mounting an elongate lens having front and rear ends in a position in which the rear end of the lens is adjacent an objective of a microscope, and adjusting the lens by moving the lens relative to the objective so that an image plane of the lens corresponds with a focal plane of the microscope objective. While maintaining the lens and objective in fixed position relative to one another, relative movement between the tissue, on the one hand, and the lens and objective, on the other hand, is effected to penetrate the tissue with the front end of the lens and to position the lens so the cells lie within a focal plane of the lens.

Other objects and features of the present invention will be in part apparent and in part pointed out hereinafter.

### BRIEF DESCRIPTION OF THE DRAWINGS

FIG. 1 is an elevation in partial section of a microscope attachment of the present invention;

FIG. 2 is a bottom plan of the attachment in partial section;

FIG. 3 is an elevation of the attachment shown inserted into a brain of a patient;

FIG. 4 is a detailed cross section of the attachment shown introducing a fluid into a brain of a patient; and

FIG. 5 is a detailed cross section of a second embodiment of the attachment shown guiding an instrument into a brain of a patient;

FIG. 6 is a view similar to FIG. 4 showing a second embodiment of the attachment; and

FIG. 7 is a view similar to FIG. 4 showing a third embodiment of the attachment.

Corresponding reference characters indicate corresponding parts throughout the several views of the drawings.

### DETAILED DESCRIPTION

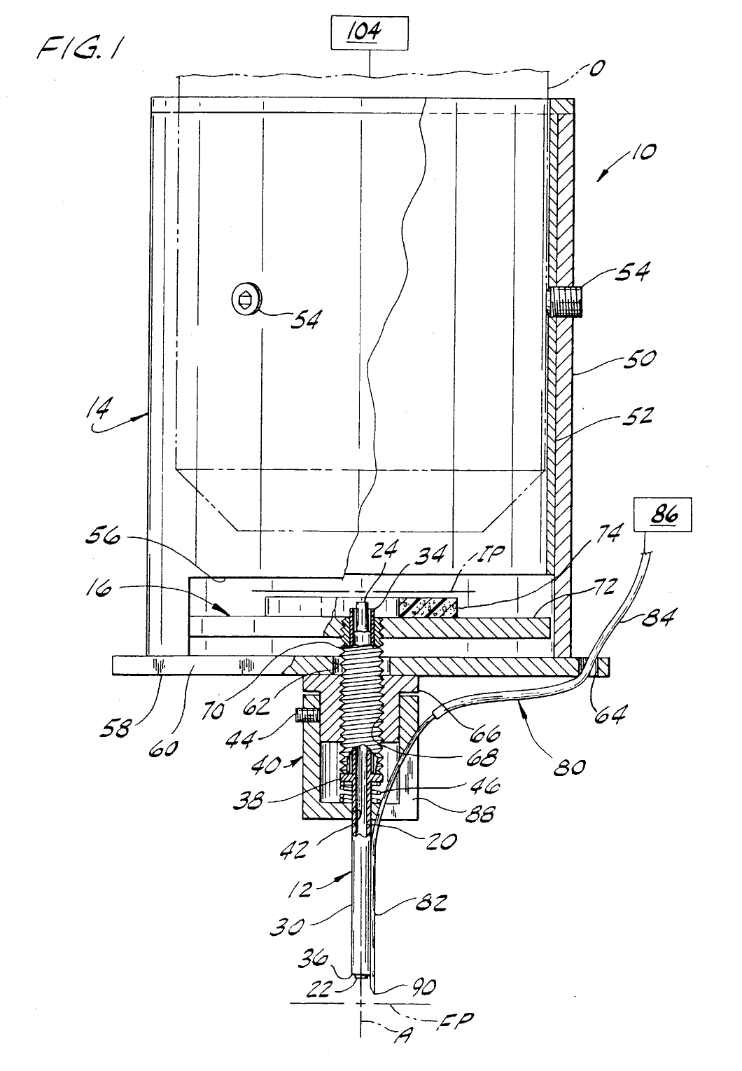

Referring now to the drawings and in particular to FIG. 1, an attachment for use with a microscope is designated in its entirety by the reference numeral 10. The attachment 10 generally comprises a lens assembly, a mount and a focusing mechanism, generally designated 12, 14 and 16, respectively.

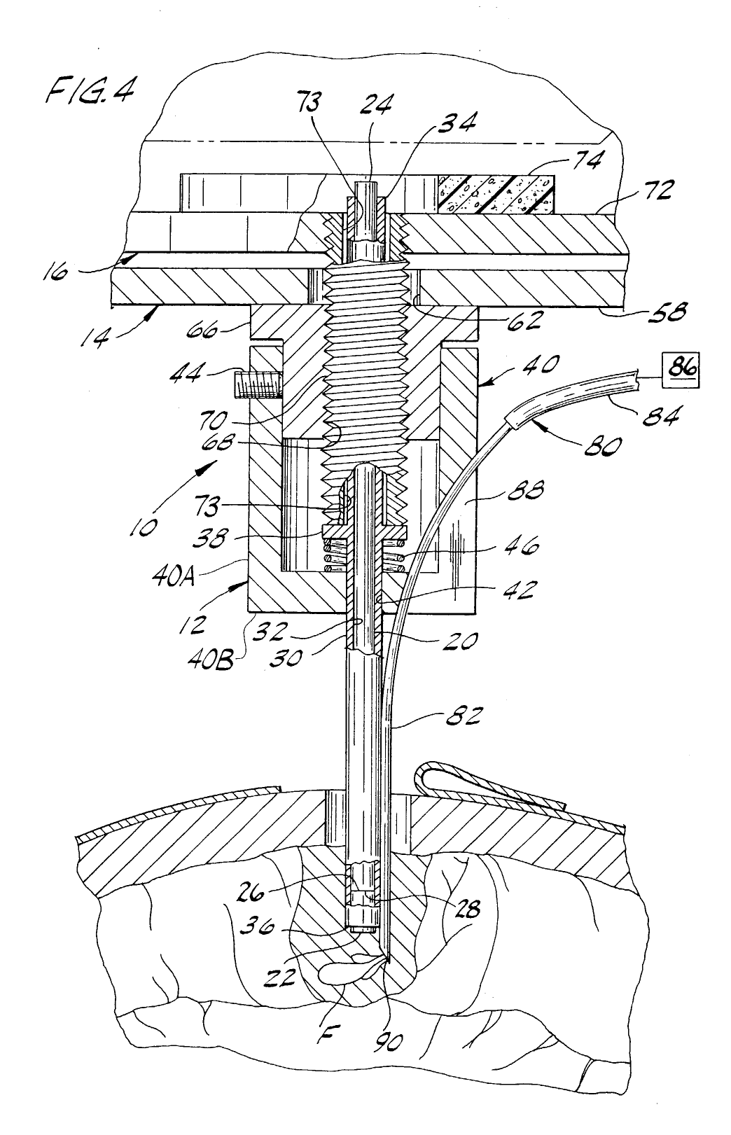

In one embodiment, the lens assembly 12 includes a unitary cylindrical lens or microlens 20 such as a Selfoc® microlens having a small diameter (e.g., less than about 3.0 mm). Selfoc is a federally registered trademark of Nippon Sheet Glass Co., Ltd. of Osaka, Japan. Selfoc® microlenses are available through NSG America, Inc. of Somerset, N.J. The microlens 20 transmits an image of a specimen (not shown) positioned at a focal plane FP of the microlens adjacent its front or lower end 22 to an image plane IP of the microlens adjacent a rear or upper end 24. As will be understood by those skilled in the art, the microlens is preferably a unitary cylindrical lens having a diameter less than about 3 mm, and more preferably less than about 0.5 mm. The microlens 20 preferably has an objective lens portion 26 (FIG. 4) and a relay lens portion 28 (FIG. 4).

In the embodiment shown in FIG. 4, a tube or sleeve 30 surrounds the microlens 20 to protect it from damage. The tube 30 has a hollow interior 32 extending downward from an upper end 34 to a tip 36 adjacent the front (lower) end 22 of the microlens 20. The tip 36 is sufficiently narrow (e.g., less than about 3 mm, and more preferably less than about 0.5 mm) to permit the tube 30 and microlens 20 to be inserted inside living tissue without severely damaging the tissue. Although other materials may be used without departing from the scope of the present invention, the tube of the preferred embodiment is an 18 gauge stainless steel tube. Alternatively, it is envisioned that the tube may be made of glass, plastic or other insulating material. The microlens 20 is adhesively bonded inside the hollow interior 32 of the tube 30 in the preferred embodiment, but it is envisioned that other means of attachment may be used and that the microlens 20 may be made removable from the hollow interior 32 of the tube 30 without departing from the scope of the present invention. The tube 30 includes a radial flange forming a collar 38 about midway between the upper end 34 and the tip 36 for engaging the focusing mechanism 16 as will be explained in further detail below. The tube 30 is held by a thimble-shaped lens holder 40 having a cylindric side wall 40A and a bottom wall 40B with a central opening 42 which slidably receives the tube. A set screw 44 threaded through the side wall 40A is provided for securing the lens holder to the mount 14. A spring 46 surrounds the tube 30 inside the lens holder. The upper end of the spring 46 abuts the collar 38 and lower end of the spring rests against the inside of the bottom wall 40B of the lens holder 40 to bias the tube 30 upward toward an objective O of the microscope and against the focusing mechanism 16.

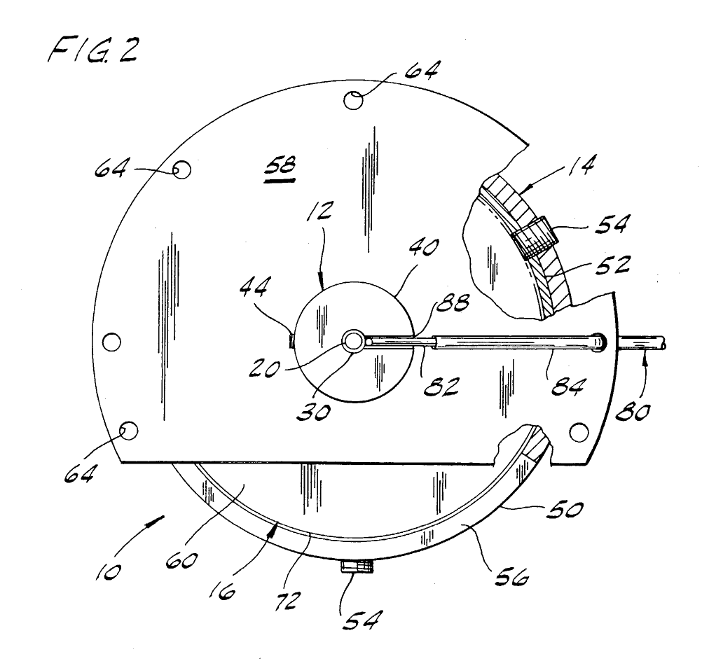

In the embodiment illustrated in FIG. 1, the mount 14 includes a cylinder 50 having an inner sleeve 52 sized for receiving a microscope objective O (shown in phantom in FIG. 1). It is envisioned that sleeves 52 having differing inner diameters may be provided to accommodate different microscope objectives O. Set screws 54 extending through the cylinder 50 and sleeve 52 engage the objective O to releasably mount the attachment 10 on the microscope. These screws 54 may have soft tips (e.g., Teflon® polymer tips) to avoid marring the objective O. (Teflon is a federally registered trademark of E.I. duPont de Nemours and Company.) As shown in FIGS. 1 and 2, an opening 56 is provided in the side of the cylinder 50 for accessing the focusing mechanism 16 as will be explained below. An end wall 58 extends across the bottom of the cylinder 50 and has an open segment 60 aligned with the opening 56 in the side of the cylinder 50 for providing additional access to the focusing mechanism 16. In addition, the wall 58 has a central aperture 62 (FIG. 1) for receiving a portion of the focusing mechanism 16 and one or more peripheral openings 64 for receiving ancillary systems which are used in combination with the attachment 10. As illustrated in FIG. 1, a lug 66 is affixed (e.g., welded or bonded) to the end wall 58 below the central aperture 62 and is received in the open upper end of the lens holder for engagement by the set screw 44 to secure the lens holder to the mount 14. A threaded hole 68 extends vertically through the lug 66 for receiving the focusing mechanism 16.

The focusing mechanism 16 includes an adjustment screw 70 having a thumb wheel 72 at its upper end and a central longitudinal bore 73 generally co-axial with the hole 68 in the lug 66 for receiving the microlens 20. The screw 70 is threaded down through the threaded hole 68 in the lug 66 and engages the collar 38 on the tube 30 surrounding the microlens 20. As will appreciated by those skilled in the art, when the thumb wheel 72 is turned, the screw 70 rotates and moves either up or down with respect to the mount 14. Because the lower end of the screw 70 engages the collar 38 of the microlens 20, the microlens 20 and tube 30 also move up or down along a longitudinal axis A of the microlens 20 but do not rotate. Therefore, rotation of the screw 70 effects vertical axial translation of the microlens 20 with respect to the objective O without rotating the tube 30 with respect to the mount 14. An annular pad 74 attached to the upper side of the thumb wheel 72 protects the microscope objective O from damage when the attachment 10 is mounted on the objective and when the focusing mechanism 16 is adjusted. Since the position of the microlens 20 may be adjusted independently of the mount 14, the microlens may be focused so that the image plane IP of the microlens corresponds with the focal plane of the microscope objective O. Further, the microlens 20 may be focused without moving the mount 14 relative to the objective O. As a result, the microlens 20 may be focused with respect to the objective O and the microlens may be moved to the precisely desired site in the tissue without affecting the focus. Further, both these adjustments may be performed without changing the position of the mount 14 on the objective O.

As previously mentioned, the attachment 10 may also include ancillary systems. For instance, the attachment 10 may have one or more fluid delivery systems, generally designated by 80 in FIG. 4. Each fluid delivery system 80 comprises, in a preferred embodiment, a micropipette 82 and flexible tubing 84 sized for receiving an inlet end of the micropipette. An upstream end of the tubing 84 is connected to a fluid source 86 and the downstream end is connected to the micropipette 82. The tubing 84 extends through one of the peripheral openings 64 in the mount 14 to hold the tubing in position. As shown in FIG. 2, a slot 88 may be provided in the lens holder 40 for holding the micropipette 82 in position with respect to the lens assembly 12 comprising the microlens 20 and tube 30. Although other means of attachment are envisioned as being within the scope of the present invention, the micropipette 82 of the preferred embodiment is adhesively bonded to the outside of the lens assembly tube 30. As will be appreciated by those skilled in the art, the micropipette 82 is somewhat compliant so it can bend as shown in FIG. 1. In addition, the flexibility of the tubing 84 permits the tubing to follow the micropipette 82 as the focusing mechanism 16 moves the microlens 20 up or down with respect to the mount 14. The outlet end 90 of the micropipette 82 is positioned adjacent the front end 22 of the microlens 20. Moreover, the outlet end 90 is angled as shown in FIG. 1 to direct fluid F (FIG. 4) toward the field of view of the microlens 20 and to provide a pointed tip for improving the ease with which the attachment 10 may be advanced into tissue. The fluid delivery system 80 may be used to deliver a preselected amount of fluid F to a desired site within the field of view of the microlens 20. For instance, a liquid medicant can be injected into the tissue so its effects can be studied through the microscope, or a stain can be applied to the tissue to improve the contrast of features of the tissue. In addition, more than one fluid delivery system 80 may be coupled with the attachment 10 for delivering more than one fluid to the site.

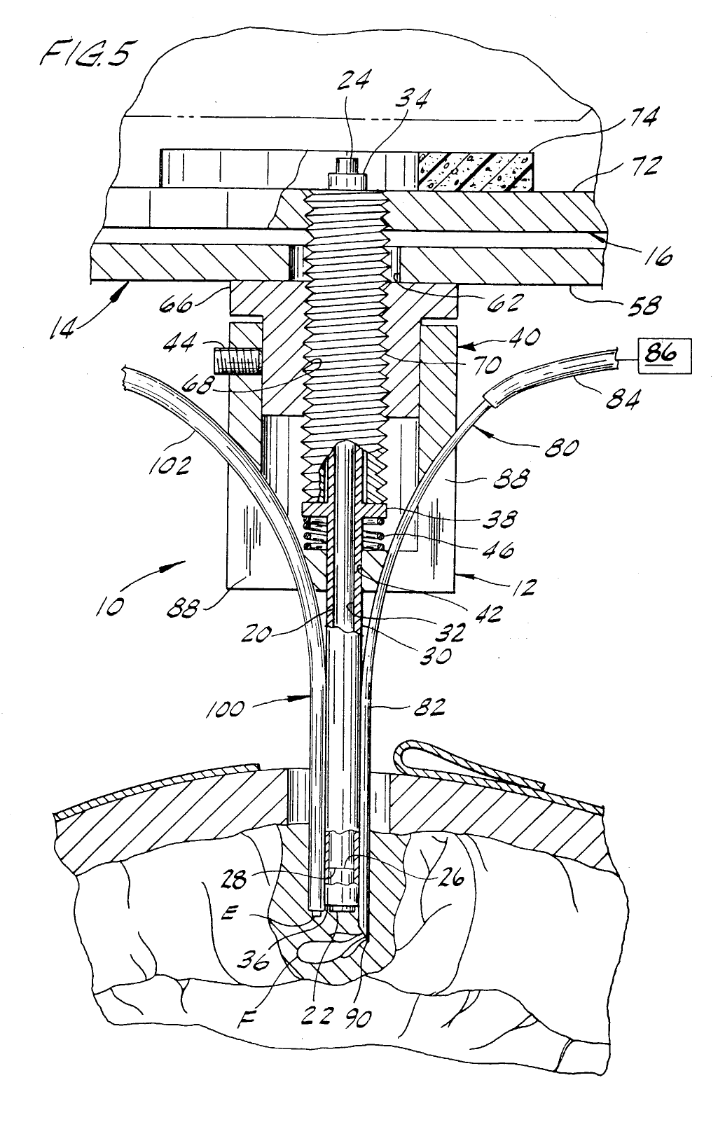

Other ancillary systems are also envisioned. For example, as shown in FIG. 5, the attachment 10 may include an instrument guidance system, generally designated 100, for guiding instruments (e.g., an electrode E) toward the site adjacent the front end 22 of the microlens 20. Although other configurations are envisioned as being within the scope of the present invention, the instrument guidance system 100 shown in FIG. 5 comprises flexible tubing 102 adhesively bonded to the outside of the lens assembly tube 30. The tubing 102 extends upward through a slot 88 provided in the lens holder 40. In addition, the tubing 102 may extend through one of the peripheral opening 64 in the mount 14 to hold the tubing in position. Depending upon the particular instrument intended to be carried by the tubing, the diameter of the tubing may vary. Because the lens assembly 12 does not rotate as the focusing mechanism 16 is adjusted, the angular position of the ancillary systems does not change with respect to the microlens 20 as the microlens is focused. As a result, the ancillary systems do not become twisted around the lens assembly 12 as the microlens 20 is focused.

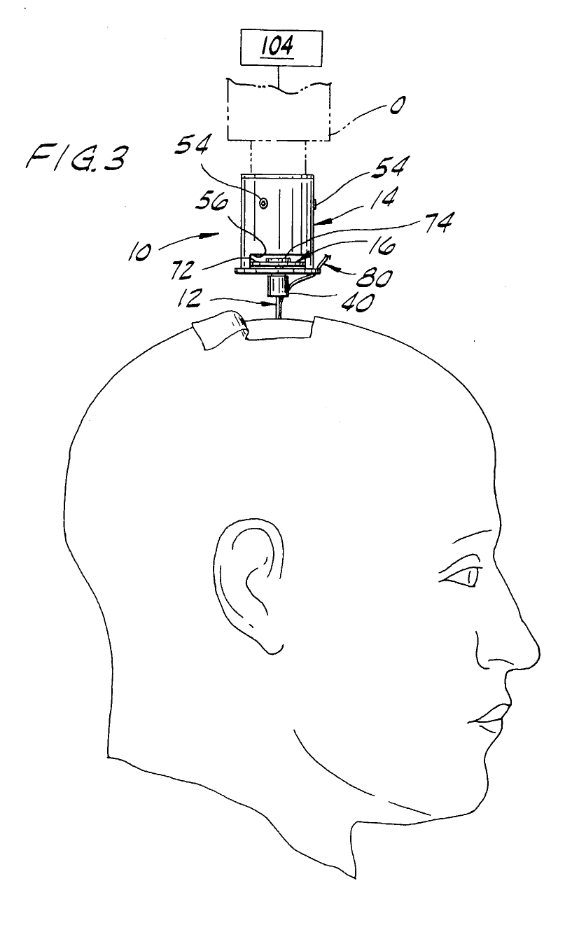

The attachment 10 of the present invention is used to view a desired site in living tissue of a host organism as shown in FIG. 3. The site is prepared by making an incision in the skin and soft tissue of the organism and removing any bone in a conventional manner. The mount 14 is positioned on a microscope objective O and the screws 54 are tightened to hold the mount in place. Once the screws 54 are tightened, the focusing mechanism 16 is adjusted by turning the thumb wheel 72 so the image plane IP of the microlens 20 corresponds with the focal plane of the microscope objective O. After the microlens 20 is focused, relative movement is effected between the microlens and objective on the one hand and the tissue on the other hand until the site on the living tissue lies within the field of view of the microlens at its focal plane FP. As will be understood by those skilled in this field, such relative movement may be effected by moving a microscope stage (not shown) holding the tissue to be viewed relative to the microlens 20, or be moving the microlens relative to the tissue. In either case, after the microlens is suitably positioned relative to the tissue to be viewed, a guide needle (not shown) can be advanced in front of the microlens 20 to allow easier penetration of dense tissue. Ancillary systems may be used to introduce fluids or guide instruments to the site.

As will be appreciated by those skilled in the art, the attachment 10 of the present invention allows use of the microscope focusing mechanism (not shown) to micromanipulate the attachment into position. Further, the attachment 10 allows sites on both the exterior and interior of the tissue to be viewed while the tissue remains in the organism. Because the fluid delivery system directs fluid to the specific site of interest, small amounts of fluid, which are effective at the site but nontoxic to tissue surrounding the site, can be used. Moreover, the lens assembly 12 may be removed from the attachment 10 to change lens elements. Because the lens assembly 12 is removable, it may be discarded after use to prevent infecting others with infectious diseases (e.g., Jacob-Creutzfelt disease) which may be present in the tissue.

As will be further appreciated by those skilled in the art, the attachment 10 of the present invention is particularly (but not exclusively) useful when used with a conventional confocal optical microscope (e.g., a single or dual photon confocal microscope) as described in the Background of the Invention so light is directed from a light source 104 (FIG. 3), such as a laser light source, through the objective O. The microlens 20 is configured (i.e., adapted) to transmit light from the source 104 to illuminate the specimen and to transmit light from the specimen (e.g., reflected or fluoresced) back through the microlens. Because a confocal microscope does not require external lighting, only a small opening (about the size of the tube 30) need be made in the tissue to accommodate the attachment 10. Thus, the tissue is subjected to less mechanical and optical trauma than it would otherwise be. The image of the illuminated specimen is transmitted back through the microlens 20 to the image plane IP of the microlens. Because the image plane IP of the microlens 20 corresponds to the focal plane of the objective O, the microscope magnifies the image so cells and other structures in the tissue may be viewed. Moreover, because light can be transmitted through several hundreds of microns of tissue and the focal plane FP of the microlens 20 can be positioned below the surface of the tissue, the attachment 10 may be used to view sub-surface portions of the tissue such as the extracellular matrix, the cells and the intracellular matrix. Further, the attachment 10 may be used to view the matrices and cellular membranes without damaging the extracellular matrix. For example, as the attachment 10 of the present invention is inserted into the extracellular matrix, arteries ahead of the microlens 20 can be viewed so the user can alter the path of the attachment as it is advanced before causing permanent and irreversible global tissue damage (e.g., brain herniation from intracranial hemorrhage). Those skilled in the art will further appreciate that the attachment 10 of the present invention may be used with a conventional epi-flourescence microscope.

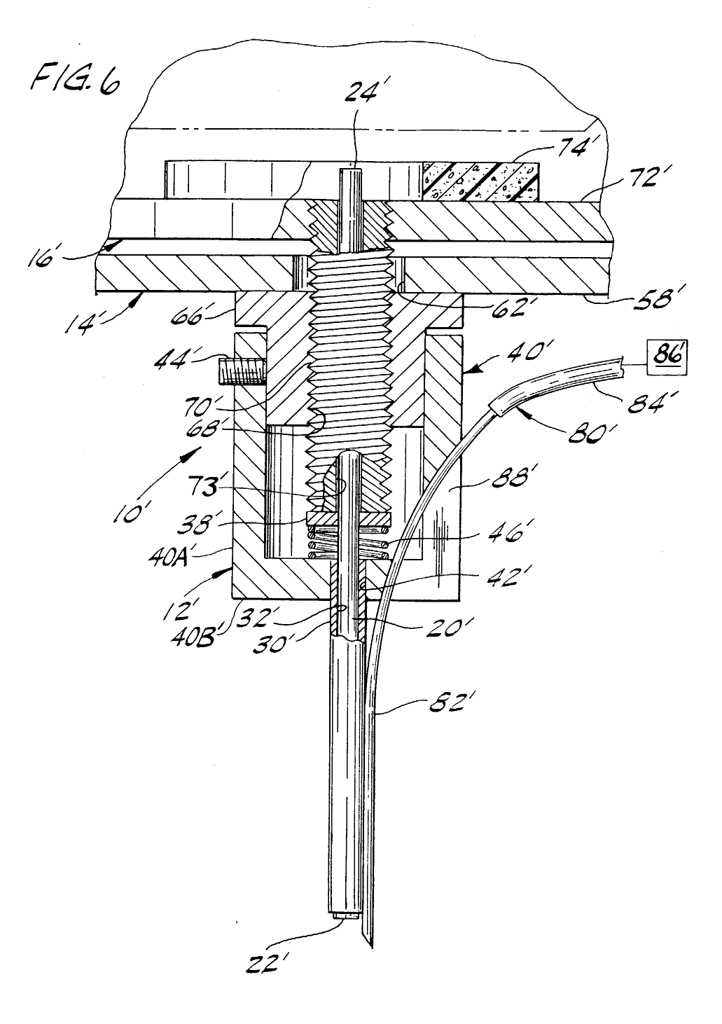

FIG. 6 shows another embodiment of the invention similar to the first embodiment of FIG. 4 and, for convenience, corresponding parts are designated by the same reference numbers but with an added “'” (prime) designation. In this embodiment, the tube 30′ surrounding the microlens 20′ has its upper end affixed (e.g., welded or bonded) to the bottom wall 40B of the lens holder 40′ so that the tube is rigidly held against both axial and rotational movement relative to the lens holder. The microlens 20′ is slidable up and down in the tube 30′ by turning the adjusting screw 70′ to position the microlens at the appropriate position. In this particular embodiment, a collar 38′ is affixed (e.g., by adhesive) directly to the microlens (which may include a protective sheath) and not to the tube 30′. The microlens 20′ extends up through the hole 73′ in the adjusting screw 70′, as in the first embodiment. A micropipette 82 and/or other suitable accessories may be attached to the tube 30′, as described previously.

The embodiment of FIG. 6 is advantageous in that the tube 30′ is held against rotation, unlike the tube 30 of the first embodiment which may tend to rotate as it is penetrates tissue due to variances in tissue density, etc. Because tube 30′ cannot rotate, there is less risk of displacement or damage to the micropipette and any other accessories on the tube 30′ when moving the microlens 20′. Also, the microlens 20′ can be easily replaced without disrupting or damaging any attachments on the tube (e.g., micropipette 82′).

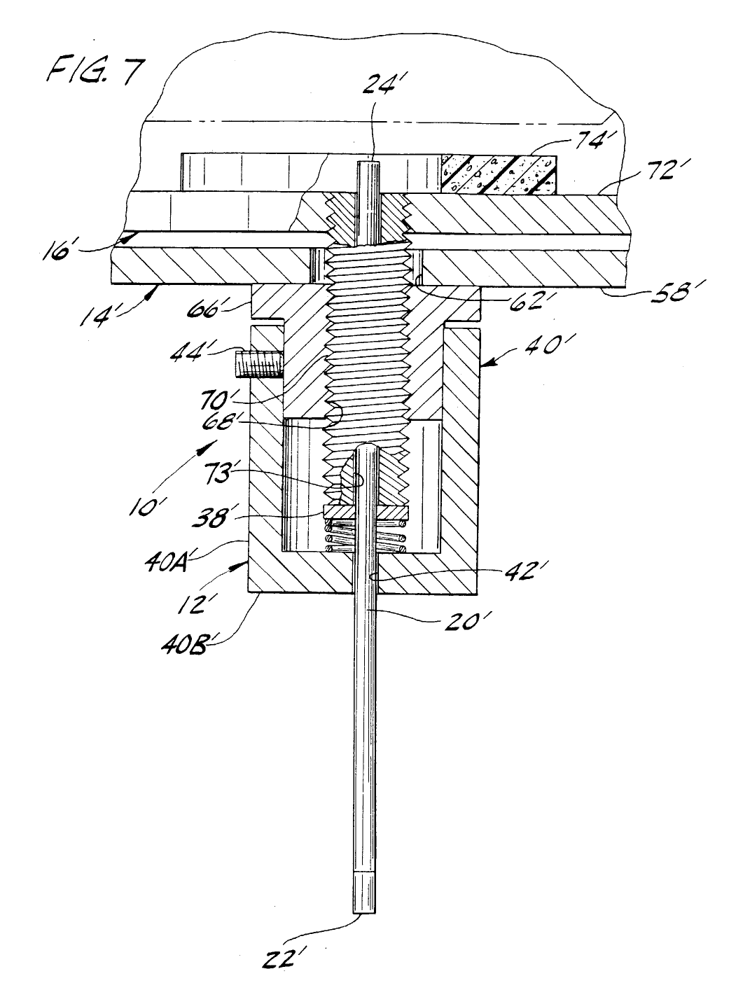

It will be understood that the lens tubes 30, 30′ may have different lengths and surround different portions of the microlens. For example, while the lens tubes 30, 30′ are shown extending down to a position closely adjacent the front end of the microlens 20, 20′, it will be understood that the tubes 30, 30′ could be longer or shorter. Further, the lens tube 30′ could be eliminated altogether, as shown in FIG. 7. Shortening or eliminating the lens tube has the advantage of reducing the volume occupied by the lens assembly in the tissue being viewed, thereby reducing the risk of tissue damage (e.g., brain injury).

It will be apparent from the foregoing that this invention is effective for illuminating cells in living tissue, and providing a clear image of the cells to the user of the microscope. The invention is useful for any microscope (e.g., confocal, epi-fluorescence) where light from a light source is transmitted through the objective to the tissue being viewed. Illumination of the tissue can occur in various ways, e.g., because light is reflected off the tissue back through the lens to the objective, or because the tissue fluoresces light back through the lens to the objective. In both of these examples, light is transmitted in both directions through the microlens.

In view of the above, it will be seen that the several objects of the invention are achieved and other advantageous results attained.

As various changes could be made in the above constructions without departing from the scope of the invention, it is intended that all matter contained in the above description or shown in the accompanying drawings shall be interpreted as illustrative and not in a limiting sense.

What is claimed is:

1. An assembly for viewing cells inside tissue of a living organism, the assembly comprising:
a microscope having an objective for magnifying an image positioned at a focal plane of the objective and a light source adapted to direct light through the objective;
an elongate lens extending from a rear end adjacent the objective to a front end configured for penetrating the tissue of the living organism to position the lens adjacent cells inside the tissue, said lens being configured for transmitting light from the light source to the cells inside the tissue of the living organism adjacent the front end of the lens to illuminate the cells and for transmitting light from said cells back through the lens to said objective, the lens having a focal plane adjacent its front end positioned at a location corresponding to the illuminated cells and an image plane adjacent its rear end; and
a focusing mechanism for moving the lens relative to the objective along a longitudinal axis of the lens to position the lens so that the image plane of the lens corresponds with the focal plane of the objective thereby permitting the cells inside the tissue of the living organism to be viewed with the microscope.

2. An assembly as set forth in claim 1 wherein said lens has a diameter of less than about 3 millimeters.

3. An assembly as set forth in claim 1 wherein said lens has a diameter of less than about 0.5 millimeters.

4. An assembly as set forth in claim 1 wherein said microscope is a confocal microscope.

5. An assembly as set forth in claim 1 further comprising a mount for mounting said focusing mechanism and said lens on said objective.

6. An assembly as set forth in claim 5 further comprising a rigid tube secured in a fixed position relative to the objective in which the tube surrounds the lens and is generally coaxial therewith, said focusing mechanism being operable to move the lens axially inside the tube.

7. An assembly as set forth in claim 6 further comprising a fluid delivery system mounted on the tube for delivering fluid to cells adjacent the front end of the lens.

8. An assembly as set forth in claim 7 wherein said fluid delivery system comprises a micropipette having an inlet end connected to a fluid source and an outlet end positioned adjacent the front end of the lens.

9. An assembly as set forth in claim 6 further comprising an instrument guidance system mounted on the tube for guiding instruments toward a site on the specimen adjacent the front end of the lens.

10. An assembly as set forth in claim 9 wherein the instrument guidance system comprises a guide extending adjacent said tube sized and shaped for guiding at least a portion of an instrument toward the site on the specimen.

11. An assembly as set forth in claim 6 wherein the focusing mechanism is operable to move the lens relative to said mount and said tube so that the image plane of the lens may be moved to correspond with the focal plane of the microscope objective without moving the mount relative to the objective.

12. An assembly as set forth in claim 5 wherein said focusing mechanism comprises an adjustment screw rotatable relative to the mount for moving the lens with respect to the microscope objective.

13. An assembly as set forth in claim 12 wherein said focusing mechanism further comprising a spring for biasing the lens toward the microscope objective.

14. An assembly as set forth in claim 12 further comprising a lens holder on the mount for holding the lens, said lens holder having a front wall with an opening in it for receiving said lens, said lens holder having a releasable connection with the mount whereby the lens holder and lens may be removed and replaced.

15. An assembly as set forth in claim 14 wherein said adjustment screw extends inside the lens holder, and wherein said lens extends through an axial opening in the adjustment screw generally aligned with the opening in the front wall of the lens holder.

16. An assembly as set forth in claim 14 further comprising a rigid tube secured in fixed position to the front wall of the lens holder and extending forward from the lens holder in a position surrounding the tube and generally coaxial therewith, said focusing mechanism being operable to move the lens axially inside the tube.

17. An assembly as set forth in claim 5 further comprising a lens holder for holding the lens, said lens holder having a releasable connection with the mount whereby the lens holder and lens may be removed and replaced.

18. An attachment for use with a microscope having an objective for receiving light from a light source, said attachment comprising:
an elongate lens having a rear end and a front end;
a mount for mounting the lens on the microscope in a position in which the rear end of the lens is adjacent the objective and its front end is configured for penetrating the tissue of the living organism to position the lens adjacent cells inside the tissue;
said lens being configured for transmitting light from the light source to the cells inside the tissue of the living organism adjacent the front end of the lens to illuminate the cells and for transmitting light from said cells back through the lens to said objective, the lens having a focal plane adjacent its front end positioned at a location corresponding to the illuminated cells and an image plane adjacent its rear end; and
a focusing mechanism for moving the lens relative to the objective along a longitudinal axis of the lens to position the lens so that the image plane of the lens corresponds with the focal plane of the objective thereby permitting the cells inside the tissue of the living organism to be viewed with the microscope.

19. An assembly as set forth in claim 18 wherein said lens has a diameter of less than about 3 millimeters.

20. An assembly as set forth in claim 18 wherein said lens has a diameter of less than about 0.5 millimeters.

21. An attachment as set forth in claim 18 further comprising a rigid tube secured in a fixed position relative to the mount in which the tube surrounds the lens and is generally coaxial therewith, said focusing mechanism being operable to move the lens axially inside the tube.

22. An attachment as set forth in claim 21 further comprising a fluid delivery system mounted on the tube for delivering fluid to cells adjacent the front end of the lens.

23. An attachment as set forth in claim 22 wherein said fluid delivery system comprises a micropipette having an inlet end connected to a fluid source and an outlet end positioned adjacent the front end of the lens.

24. An attachment as set forth in claim 21 further comprising an instrument guidance system mounted on the tube for guiding instruments toward a site on the specimen adjacent the front end of the lens.

25. An attachment as set forth in claim 24 wherein the instrument guidance system comprises a guide extending adjacent said tube sized and shaped for guiding at least a portion of an instrument toward the site on the specimen.

26. An attachment as set forth in claim 18 wherein the focusing mechanism is operable to move the lens relative to said mount and said tube so that the image plane of the lens may be moved to correspond with the focal plane of the microscope objective without moving the mount relative to the objective.

27. An attachment as set forth in claim 18 wherein said focusing mechanism comprises an adjustment screw rotatable relative to the mount for moving the lens with respect to the microscope objective.

28. An attachment as set forth in claim 27 wherein said focusing mechanism further comprising a spring for biasing the lens toward the microscope objective.

29. An attachment as set forth in claim 28 further comprising a lens holder on the mount for holding the lens, said lens holder having a front wall with an opening in it for receiving said lens, said lens holder having a releasable connection with the mount whereby the lens holder and lens may be removed and replaced.

30. An attachment as set forth in claim 29 wherein said adjustment screw extends inside the lens holder, and wherein said lens extends through an axial opening in the adjustment screw generally aligned with the opening in the front wall of the lens holder.

31. An attachment as set forth in claim 30(further comprising a rigid tube secured in fixed position to the front wall of the lens holder and extending forward from the lens holder in a position surrounding the tube and generally coaxial therewith, said focusing mechanism being operable to move the lens axially inside the tube.

32. An attachment as set forth in claim 18 further comprising a lens holder for holding the lens, said lens holder having a releasable connection with the mount whereby the lens holder and lens may be removed and replaced.

33. A method of viewing cells inside tissue of living organisms comprising the steps of:
mounting an elongate lens having front and rear ends in a position in which the rear end of the lens is adjacent an objective of a microscope;
adjusting the lens by moving the lens relative to the objective so that an image plane of the lens corresponds with a focal plane of the microscope objective; and
while maintaining the lens and objective in fixed position relative to one another, effecting relative movement between the tissue, on the one hand, and the lens and objective, on the other hand, to penetrate the tissue with the front end of the lens and to position the lens so the cells lie within a focal plane of the lens.

34. A method as set forth in claim 33 further comprising transmitting light from a light source through the lens objective and the lens to said tissue.

35. A method as set forth in claim 34 wherein said light source is a laser light source.

36. A method as set forth in claim 33 wherein said lens in mounted in a lens holder, and wherein said method further comprises removing said lens holder and lens from the microscope and replacing them with a different lens holder and lens combination.

37. A method as set forth in claim 33 further comprising enclosing said lens in a rigid tube, and delivering fluid to said tissue through a conduit attached to said tube.
